(19) United States
(12) Patent Application Publication
(10) Pub. No.: US 2025/0326416 A1
(43) Pub. Date: Oct. 23, 2025

(54) PORTABLE PAD WITH PAD CARRYING CART AND METHODS OF USE

(71) Applicant: Wayne E. Quarles, Cleveland, GA (US)

(72) Inventor: Wayne E. Quarles, Cleveland, GA (US)

(21) Appl. No.: 19/096,075

(22) Filed: Mar. 31, 2025

Related U.S. Application Data
(60) Provisional application No. 63/637,227, filed on Apr. 22, 2024.

(51) Int. Cl. B62B 1/12; B62B 1/14; F16M 5/00

(52) U.S. Cl. CPC B62B 1/12; B62B 1/14; F16M 5/00

(57) ABSTRACT

A transport cart having two or more wheels, at least one axel connecting the two or more wheels, a pair of lifting arms preferably a first or left lifting arm and a second or right lifting arm, the pair of lifting arms connected to the axel, each of the pair of lifting arms having a spaced apart pair of apertures or slotted collars to receive a set of carrying pins or rods slide able therein, and a pair of lever arms preferably a first or left lever arm and a second or right lever arm, wherein the first or left lever arm is affixed to the first or left lifting arm and the second or right lever arm is affixed to the second or right lifting arm, and thus, to move modified portable slab, HVAC compressor, and generator.

### CROSS-REFERENCE TO RELATED APPLICATIONS

To the full extent permitted by law, the present United States Non-provisional Patent Application hereby claims priority to and the full benefit of United States Provisional Application entitled “Portable Pad with Pad Carrying Cart and Methods of Use,” having assigned Ser. No. 63/637,227, filed on Apr. 22, 2024, incorporated herein by reference in its entirety.

### FIELD OF THE DISCLOSURE

The present disclosure relates to portable utility carts and more specifically, to a carrying cart configured to transport modified items to engage the cart.

### BACKGROUND

Portable heating, ventilation, and air conditioning (HVAC) systems, power generation equipment, and utility carts have become essential tools in various settings, including construction sites, outdoor events, and emergency response scenarios, where access to electricity and functional workspaces is often limited. Standalone HVAC compressor units and generators often mounted on slabs or platforms for stability require transport of the slab as well as transport of the HVAC compressor units and generators. Transport of multiple components has been accomplished using a platform utility cart, adding significant weight to the transport. This fragmented approach increases logistical complexity, setup time, and the risk of equipment instability, particularly in uneven terrain where mobility and compactness are paramount.

Generators, typically standalone units, provide a reliable power source but are often bulky, heavy, and difficult to transport efficiently alongside other equipment. Similarly, portable slabs or work surfaces, such as foldable tables or platforms, are used to support tools and materials but lack integration with power systems, requiring users to manage multiple pieces of equipment. This disjointed approach increases setup time, reduces mobility, and complicates logistics, particularly in remote or dynamic environments where efficiency and adaptability are critical.

Therefore, it is readily apparent that there is a recognizable unmet need for a carrying cart to transport a modified portable slab, an HVAC compressor, and a generator and methods of use that may be configured to address at least some aspects of the problems discussed above.

### SUMMARY

Briefly described, in an example embodiment, the present disclosure may overcome the above-mentioned disadvantages and may meet the recognized need for a carrying or transport cart to transport a modified portable slab, HVAC compressor, and generator and methods of use to provide a transport apparatus to move modified portable slab, HVAC compressor, and generator, the preferred transport apparatus being a transport cart having two or more wheels, at least one axel connecting the two or more wheels, a pair of lifting arms preferably a first or left lifting arm and a second or right lifting arm, the pair of lifting arms connected to the axel, each of the pair of lifting arms having a spaced apart pair of apertures or slotted collars to receive a set of carrying pins or rods slide able therein, and a pair of lever arms preferably a first or left lever arm and a second or right lever arm, wherein the first or left lever arm is affixed to the first or left lifting arm and the second or right lever arm is affixed to the second or right lifting arm.

Accordingly, in one aspect, the present disclosure may include a portable slab having at least two conduits or conduit sections formed therein to enable an attachment device such as a set of carrying pins or rods to be positioned there through to removably affix the portable slab having at least two conduits or conduit sections formed therein to the pair of lifting arms having a spaced apart pair of apertures or slotted collars to receive the set of carrying pins or rods slide able therein.

Accordingly, in another aspect, the present disclosure may include an HVAC compressor or portable generator having at least two conduits or conduit sections formed therein to enable an attachment device such as a set of carrying pins or rods to be positioned there through to removably affix the portable slab having at least two conduits or conduit sections formed therein to the pair of lifting arms having a spaced apart pair of apertures or slotted collars to receive the set of carrying pins or rods slide able therein.

Accordingly, in another aspect, the present disclosure may include other heavy portable apparatus having at least two conduits or conduit sections formed therein to enable an attachment device such as a set of carrying pins or rods to be positioned there through to removably affix the portable slab having at least two conduits or conduit sections formed therein to the pair of lifting arms having a spaced apart pair of apertures or slotted collars to receive the set of carrying pins or rods slide able therein.

In an exemplary embodiment of a transport apparatus for carrying a portable device, comprising at least two wheels, a pair of lifting arms having a first lifting arm and a second lifting arm, each the pair of lifting arms being rotationally connected to one of the at least two wheels, wherein each of the pair of lifting arms includes a spaced apart pair of apertures configured to receive a set of carrying pins slidable therein, a pair of lever arms having a first lever arm and a second lever arm, wherein the first lever arm is affixed to the first lifting arm and the second lever arm is affixed to the second lifting arm, and a portable device having at least two conduits formed therein, the portable device being removably affixed to the pair of lifting arms by the set of carrying pins positioned through the at least two conduits and the spaced apart pair of apertures of each of the pair of lifting arms.

In a second exemplary embodiment of a transport apparatus for carrying a portable device, comprising at least two wheels, a first lifting arm and a second lifting arm, each rotationally connected to at least one of the at least two wheels, wherein each of the first lifting arm and the second lifting arm includes a pair of slotted collars configured to receive a set of carrying rods slidable therein, a first lever arm affixed to the first lifting arm and a second lever arm affixed to the second lifting arm, and a portable device selected from a group consisting of a portable slab, an AC compressor, a generator, and a combination thereof, the portable device having at least two conduit sections formed therein, wherein the portable device is removably affixed to the first lifting arm and the second lifting arm by the set of carrying rods positioned through the at least two conduit sections and the pair of slotted collars of each of the first lifting arm and the second lifting arm.

In an alternate exemplary embodiment of a mounting pad, the mounting pad includes a planar dimensioned solidifying material, one or more elongated reinforcement devices imbedded therein the material to strengthen the material, and at least two spaced apart conduits positioned therethrough the material.

It is an object of the disclosure herein to provide a transport apparatus and modified slab, HVAC compressor, or generator or other like transportable device requiring transport to be modified to engage the transport apparatus for quick and easy hook up, lifting, and traversing, from point A to point B and lowering into position transportable device.

It is an object of the disclosure herein to provide a pair of conduits or variety of conduits and matching carrying pins or rods and include variations in size, material, shape, form, position, and function used whether integrated therein or affixed thereto the modified portable slab, HVAC compressor, and generator or other like transportable device.

It is an object of the disclosure herein to provide a transport apparatus having a width adjustable pair of lifting arms and straw-holding structure that is inexpensive to manufacture and easy to deploy in a high-volume commercial environment such as a quick-service food restaurant or other food service business.

It is an alternate object of the disclosure herein to provide a crossbar or width-adjustable crossbar between the pair of lever arms, preferably first or left lever arm and second or right lever arm.

A feature of the present disclosure includes a portable slab configured to engage the transport cart to transport the portable slab to enable hook up, lifting, traversing, and lowering of the portable slab.

A feature of the present disclosure includes an HVAC compressor configured to engage the transport cart to transport the HVAC compressor to enable hook up, lifting, traversing, and lowering of the HVAC compressor.

A feature of the present disclosure includes a generator configured to engage the transport cart to transport the generator to enable hook up, lifting, traversing, and lowering of the generator.

A feature of the present disclosure includes a carrying cart that provides a single, portable solution that combines an HVAC compressor and portable slab combination to engage the transport cart to transport the HVAC compressor and portable slab combination to enable hook up, lifting, traversing, and lowering of the generator and HVAC compressor and portable slab combination, eliminating the need to transport separate units.

A feature of the present disclosure includes a width-adjustable/modifiable transport cart having a compact design that enhances mobility, allowing easy deployment in remote or uneven terrains like construction sites or disaster zones.

A feature of the present disclosure includes a width adjustable/modifiable transport cart adaptability that supports various HVAC unit sizes, portable slabs, generators, HVAC compressor and portable slab combination, and other heavy portable devices, increasing versatility for different applications.

These and other features of the a carrying or transport cart to transport a modified portable slab, HVAC compressor, and generator and methods of use will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The present disclosure for a carrying or transport cart to transport a modified portable slab, HVAC compressor, and generator and methods of use and methods of use will be better understood by reading the Detailed Description of the Preferred and Selected Alternate Embodiments with reference to the accompanying drawing Figures, in which like reference numerals denote similar structure and refer to like elements throughout, and in which:

FIG. 1A is a perspective side view of an exemplary embodiment of a transport cart according to select embodiments of the disclosure;

FIG. 1B is a perspective back view of an exemplary embodiment of a transport cart according to select embodiments of the disclosure;

FIG. 1C is a partially exploded side view of an exemplary embodiment of a transport cart according to select embodiments of the disclosure;

FIG. 1D is a partial perspective side view of an exemplary embodiment of a transport cart shown in raise position according to select embodiments of the disclosure;

FIG. 1E is a partial perspective side view of an exemplary embodiment of a transport cart shown in raise position according to select embodiments of the disclosure;

FIG. 2A is a perspective side view of an exemplary embodiment of a portable slab according to select embodiments of the disclosure;

FIG. 2B is a top view of an exemplary embodiment of a portable slab according to select embodiments of the disclosure;

FIG. 2C is a cross-section side view of an exemplary embodiment of a portable slab according to select embodiments of the disclosure;

FIG. 3A is a perspective side view of an exemplary embodiment of a portable slab with a transport cart positioned there above according to select embodiments of the disclosure;

FIG. 3B is a perspective side view of an exemplary embodiment of a portable slab with a transport cart positioned thereabove with the first pin removed according to select embodiments of the disclosure;

FIG. 3C is a perspective side view of an exemplary embodiment of a portable slab with the first pin inserted therethrough the transport cart and the second pin removed according to select embodiments of the disclosure;

FIG. 3D is a perspective side view of an exemplary embodiment of a portable slab with first pin and second pin inserted therethrough transport cart and ready for transport according to select embodiments of the disclosure;

FIG. 4A is a perspective side view of an exemplary embodiment of a generator with a transport cart positioned there around according to select embodiments of the disclosure;

FIG. 4B is a side view of an exemplary embodiment of a generator with a transport cart positioned there around according to select embodiments of the disclosure;

FIG. 4C is a perspective side view of an exemplary embodiment of a generator pinned to a transport cart ready for transport according to select embodiments of the disclosure;

FIG. 5A is a perspective side view of an exemplary embodiment of a generator unit and portable slab with a transport cart positioned there around according to select embodiments of the disclosure;

FIG. 5B is a perspective side view of an exemplary embodiment of a generator unit and portable slab pinned to a transport cart ready for transport according to select embodiments of the disclosure;

FIG. 6A is a perspective side view of an exemplary embodiment of an HVAC compressor unit and portable slab combination with a transport cart positioned there around according to select embodiments of the disclosure; and

FIG. 6B is a perspective side view of an exemplary embodiment of an HVAC compressor unit and portable slab combination pinned to a transport cart ready for transport according to select embodiments of the disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

In describing the exemplary embodiments of the present disclosure, as illustrated in the figures, specific terminology is employed for clarity. The present disclosure, however, is not intended to be limited to the specific terminology selected; it is to be understood that each specific element includes all technical equivalents that operate in a similar manner to accomplish similar functions. Embodiments of the claims may, however, be embodied in many different forms and should not be construed as limited to the embodiments set forth herein. The examples set forth herein are non-limiting examples and are merely examples among other possible examples. It is recognized herein that the optimum dimensional relationships, to include variations in size, materials, shape, form, position, connection, function and manner of operation, assembly, and use, are intended to be encompassed by the present disclosure.

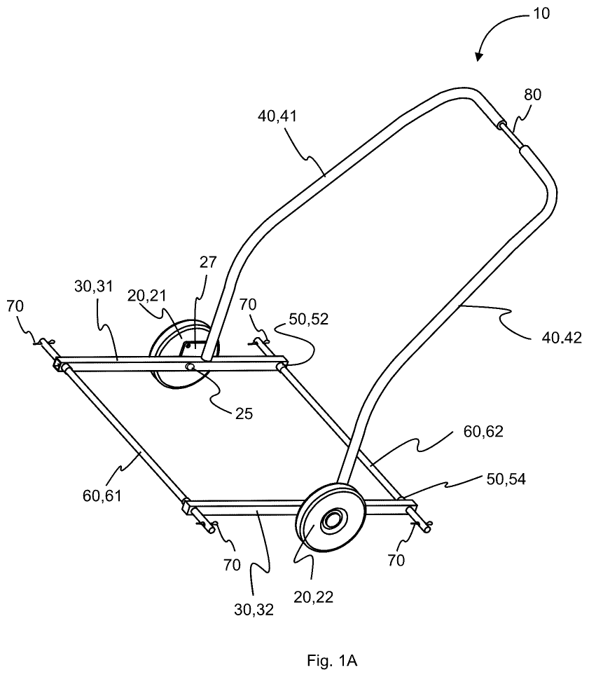

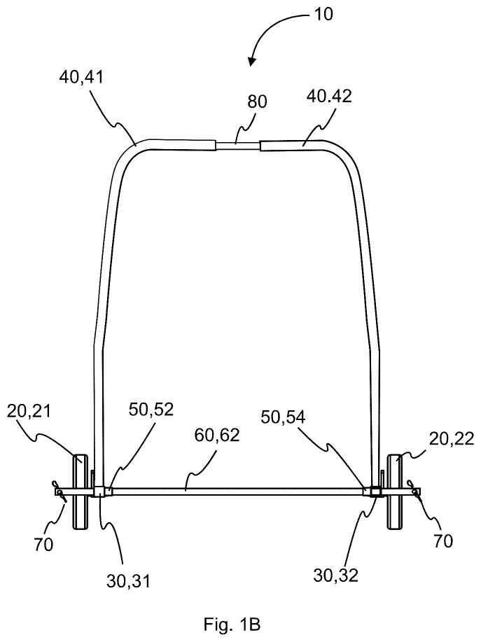

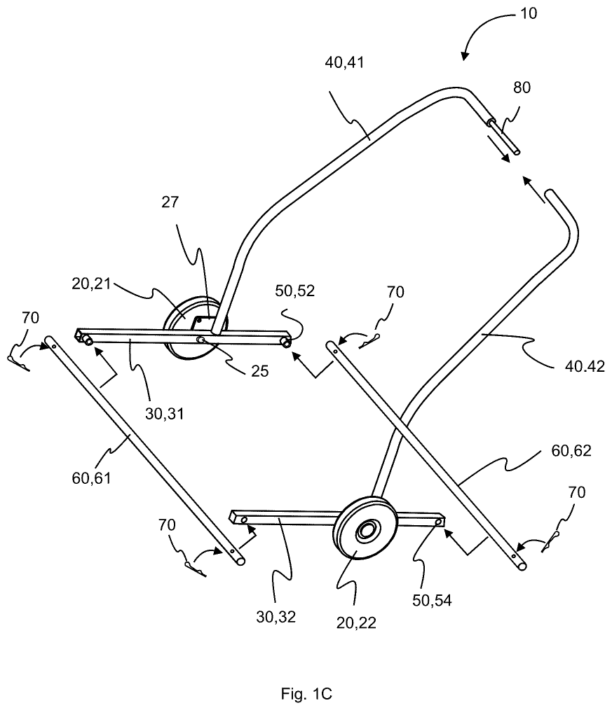

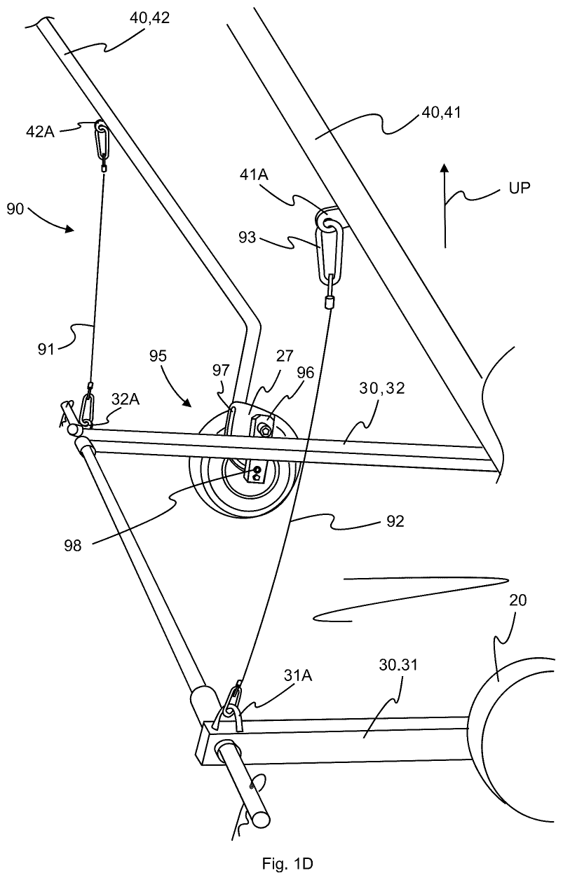

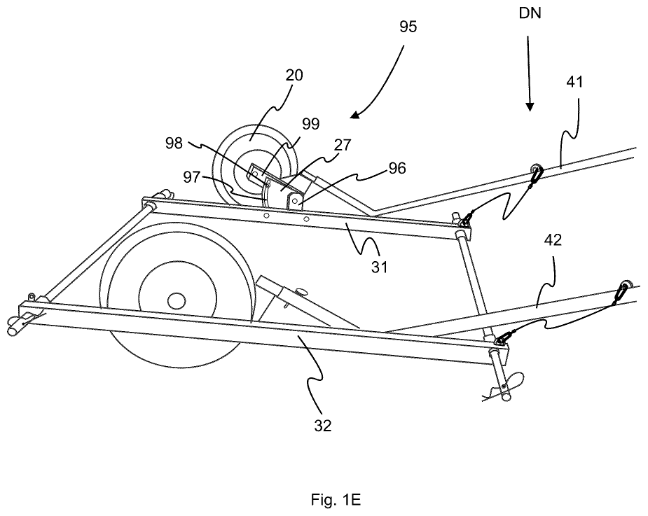

Referring now to FIGS. 1A, 1B, and 1C, by way of example, and not limitation, there is illustrated an example embodiment of a transport apparatus to transport heavy equipment such as, portable devices/equipment, portable heating, ventilation, and air conditioning (HVAC) systems, power generation equipment, mounting base or slab and the like, portable equipment PE, in various settings, including construction sites, outdoor events, and emergency response scenarios, such as transport cart 10 may include at least two or two or more wheels 20, including first or left wheel 21 and second or right wheel 22, at least one axel 25 and at least one or mounting plate 27 are utilized to connect two or more wheels 20 to enable rolling transport of or traverse thereof transport cart 10 across terrain or ground G and uneven terrain G.

It is contemplated herein that first or left wheel 21 and second or right wheel 22 may be rotationally affixed to preferably first or left lifting arm 31 and second or right lifting arm 32, respectively, to proximate a center or central position thereof pair of lifting arms 30.

It is further contemplated herein that at least one axle 25 may be rotationally affixed therethrough first or left lifting arm 31 and second or right lifting arm 32 to rotationally affix first or left wheel 21 and second or right wheel 22 thereto first or left lifting arm 31 and second or right lifting arm 32 proximate a center or central position thereof pair of lifting arms 30.

It is contemplated herein that pair of lifting arms 30 preferably first or left lifting arm 31 and second or right lifting arm 32, which may be to make width slidable/adjustable to accommodate hook up, varying size fitting (width), lifting, traversing, and lowering of portable equipment PE.

Furthermore, each of pair of lifting arms 30 may include spaced apart pairs of slotted collars, apertures, lugs, studs, dowels, sleeve, bushing, coupling, flange such as retaining collar(s) 50, a small protrusion or feature extending or protruding to the inside of transport cart 10 and positioned proximate each end of each of pair of lifting arms 30, and designed to secure or align a component during assembly or attachment. For example, first or left lifting arm 31 may include first retaining collar 51 and second retaining collar 52 positioned facing inward relative to transport cart 10 and proximate each end of first or left lifting arm 31, and second or right lifting arm 32 may include third retaining collar 53 and fourth retaining collar 54 positioned facing inward relative to transport cart 10 and proximate each end of second or right lifting arm 32.

It is contemplated herein that retaining collar(s) 50 may alternatively be aperture(s) 50 first or left lifting arm 31 may include first aperture 51 and second aperture 52 proximate each end of first or left lifting arm 31, and second or right lifting arm 32 may include third aperture 53 and fourth aperture 54 proximate each end of second or right lifting arm 32.

Furthermore, transport cart 10 may include a set of elongated bars or set of carrying rods, such as pair of pins 60, including first or front pin 61 and second or back pin 62. Preferably, first or front pin 61 may be fitted, slid, or inserted therein first retaining collar 51 of first or left lifting arm 31, and second retaining collar 52 and second or back pin 62 may be fitted, slid, or inserted therein third retaining collar 53 and fourth retaining collar 54 of second or right lifting arm 32.

It is contemplated herein that of pins 60, including first or front pin 61 and second or back pin 62 may be utilized to removably attach a variety of portable equipment PE, group consisting of, or such as heating, ventilation, and air conditioning (AC) systems, power generation, mounting base or slab and the like to lifting arms 30 preferably first or left lifting arm 31 and second or right lifting arm 32. Moreover, pins 60, including first or front pin 61 and second or back pin 62 may include latch 70, such as pins, cotter, rings, cotter pins, snap pins, or other devices to secure pins 60, including first or front pin 61 and second or back pin 62 thereto lifting arms 30 preferably first or left lifting arm 31 and second or right lifting arm 32 during transport of portable equipment PE.

It is contemplated herein that pins 60 varies in at least one of size, material, shape, form, and function.

Still furthermore, pair of lever arms 40 preferably includes first or left lever arm 41 and second or right lever arm 42, wherein the first or left lever arm 41 is preferably affixed on one end to first or left lifting arm 31 proximate one side of first or left wheel 21 and second or right lever arm 42 is preferably affixed on one end to second or right lifting arm 32 proximate one side of second or right wheel 22 to provide leverage to tilt or provide leverage to or act as a lever for first or left lifting arm 31 and second or right lifting arm 32 and to enable hook up, lifting, traversing, and lowering of portable equipment PE.

It is contemplated herein that pair of lever arms 40 preferably includes first or left lever arm 41 and second or right lever arm 42, which may be angled, bent, connected, to make width slidable/adjustable, and the like to accommodate hook up, varying size fitting (width), lifting, traversing, and lowering of portable equipment PE.

It is further contemplated herein that pair of lever arms 40 preferably includes first or left lever arm 41 and second or right lever arm 42, which may include a width spacer 80 removable and slidably connecting other ends of first or left lever arm 41 and second and right lever arm 42 one to the other to enable size fitting (width) adjustment of first or left lifting arm 31 and second or right lifting arm 32 to releasably affix to portable equipment PE.

Transport cart 10, including pair of lifting arms 30 preferably first or left lifting arm 31 and second or right lifting arm 32, pins 60, including first or front pin 61 and second or back pin 62 (¾″ tubing that is ⅛″ thick and other sizes), lever arms 40 preferably includes first or left lever arm 41 and second or right lever arm 42 are preferably constructed of metal tubing, as metal tubing offers a variety of materials, sizes, forms, and shapes; however, other suitable materials such as steel, aluminum, plastic, wood, composites, or the like, can be utilized, provided such material has sufficient strength and/or durability as would meet the purpose described herein. Two or more wheels 20, including first or left wheel 21 and second or right wheel 22, are preferably constructed of rubber, as rubber (whether pneumatic or solid) offers a variety of durability, sizes, forms, and shapes; however, other suitable materials such as steel, aluminum, plastic, wood, composites, or the like, can be utilized, provided such material has sufficient strength and/or durability as would meet the purpose described herein.

Referring now to FIGS. 1D and 1E, by way of example, and not limitation, there is illustrated an example embodiment of transport cart 10 shown in lowered position ready for engagement or disengagement and raised position ready for transport. Transport cart 10 include one or more features to raise and lower first or left lifting arm 31 and second or right lifting arm 32 (95) and to stabilize (90) a heavy object thereon. For example, transport cart 10 may include stabilizer ties or straps, such as cables 90, such as first cable 91 and second cable 92 removeably affixed between to first or left lifting arm 31 and second or right lifting arm 32, and first or left lever arm 41 and second or right lever arm 42, respectively. Moreover, first or left lifting arm 31 and second or right lifting arm 32 and first or left lever arm 41 and second or right lever arm 42 may include a grommet, metal loop, link or the like such as, D-ring 31A, 32A, 41A, and 42 A, respectively. Furthermore, first cable 91 and second cable 92 may include carabineer, clasps, or the like such as, latch 93 on both ends of first cable 91 and second cable 92.

Cables 90 connected between first or left lifting arm 31 and second or right lifting arm 32, and first or left lever arm 41 and second or right lever arm 42 assist with lifting and stabilizing an object affixed to first or left lifting arm 31 and second or right lifting arm 32 when first or left lever arm 41 and second or right lever arm 42 are moved in an upward direction, raised R.

Moreover, mounting plate 27 may include mounting bracket 96 configured to affix mounting plate 27 thereto each of first or left lifting arm 31 and second or right lifting arm 32. Mounting plate 27 may include a pair of lifting cams, such as first and second lifting cam 95 to raise and lower wheels 20 relative to first or left lifting arm 31 and second or right lifting arm 32. Wheel 2 may be rotationally mounted to one end of wheel arm 99 and the other end of wheel arm 99 may be pivotably affixed to pivot pin affixed to mounting bracket 96. Midsection of wheel arm 99 may include guide pin 98 configured to traverse curved slot 97 cut therein mounting plate 27 to operate lifting cam 95 to raise and lower wheels 20. When first or left lever arm 41 and second or right lever arm 42 are raised UP guide pin 98 traverses down curved groove, such as curved slot 97 lifting cam 95 raises first or left lifting arm 31 and second or right lifting arm 32. When first or left lever arm 41 and second or right lever arm 42 are lowered DN guide pin 98 traverses down curved slot 97 and lifting cam 95 lowers first or left lifting arm 31 and second or right lifting arm 32.

It is contemplated herein that one or more features to raise and lower first or left lifting arm 31 and second or right lifting arm 32 (95) and to stabilize (90) a heavy object thereon, via cables 90 and of lifting cams, such as first and second lifting cam 95 to raise and lower wheels 20.

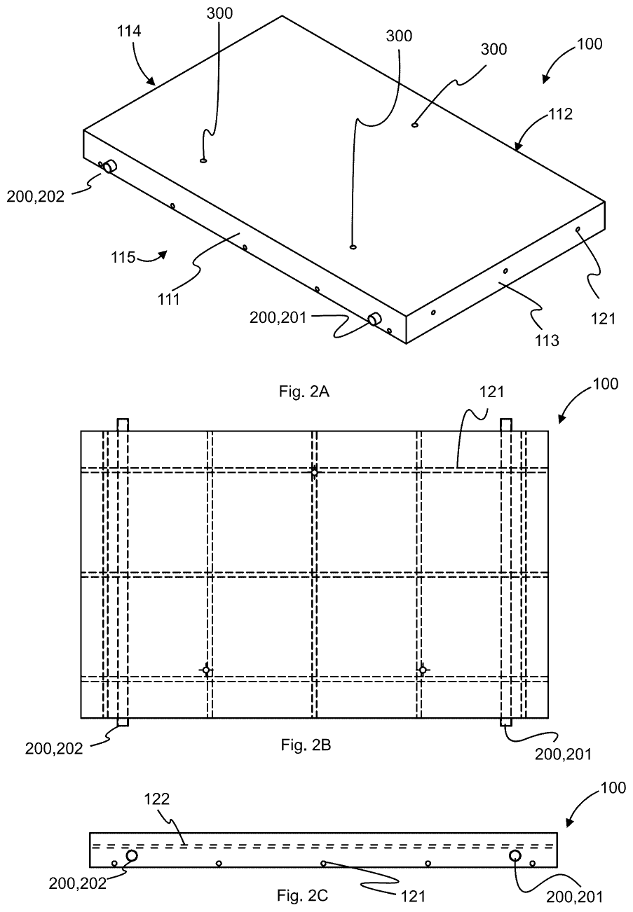

Referring now to FIGS. 2A, 2B, and 2C, by way of example, and not limitation, there is illustrated an example embodiment of portable equipment PE, more specifically, a mounting pad or base, such as slab 100. Slab 100 is preferably a planar dimensioned solidifying material or structure having a top side 110, left side 111, right side 112, front side 113, back side 114, and bottom side 115. Slab 100 may include one or more elongated reinforcement devices 121, such as rebar, wire mesh, plastic, or composite filaments imbedded therein to strengthen slab 100.

Slab 100 preferably includes at least two conduit sections or more, such as at least two spaced apart conduits 200 running or planar positioned therethrough slab 100 from preferably left side 111 to right side 112, such as first conduit 201 and second conduit 202. Conduits 200, such as first conduit 201 and second conduit 202 are preferably configured to receive one of pins 60, including first or front pin 61 and second or back pin 62 therethrough to connect slab 100, conduits 200, pins 60 thereto pair of lifting arms 30 preferably first or left lifting arm 31 and second or right lifting arm 32 of transport cart 10.

Slab 100 is preferably constructed of concrete with one or more elongated reinforcement devices imbedded, such as rebar 121 and welded box shaped wire 122 formed therein (such as ⅜ inch rebar, welded wire 2″×4″ and other sizes), as concrete offers a variety of materials, sizes, forms, and shapes; however, other suitable materials such as plastic or composite, steel, aluminum, treated wood, or the like, can be utilized, provided such material has sufficient strength, corrosion resistance, and/or durability as would meet the purpose described herein.

Conduits 200 are preferably constructed of plastic tubing (such as one inch inner diameter and other sizes), as plastic tubing offers a variety of materials, sizes, forms, and shapes; however, other suitable materials such as steel, aluminum, plastic, wood, composites, or the like, can be utilized, provided such material has sufficient strength and/or durability as would meet the purpose described herein.

Slab 100 may include one or more threaded anchor holes 300 formed or constructed therein to anchor other portable equipment PE thereto slab 100.

It is contemplated herein that conduits 200 may be substituted for pins 60 (now marked as 200) integrated into slab 100 and be utilized directly to removably attach a variety of portable equipment PE for direct transport of slab 100 by transport cart 10.

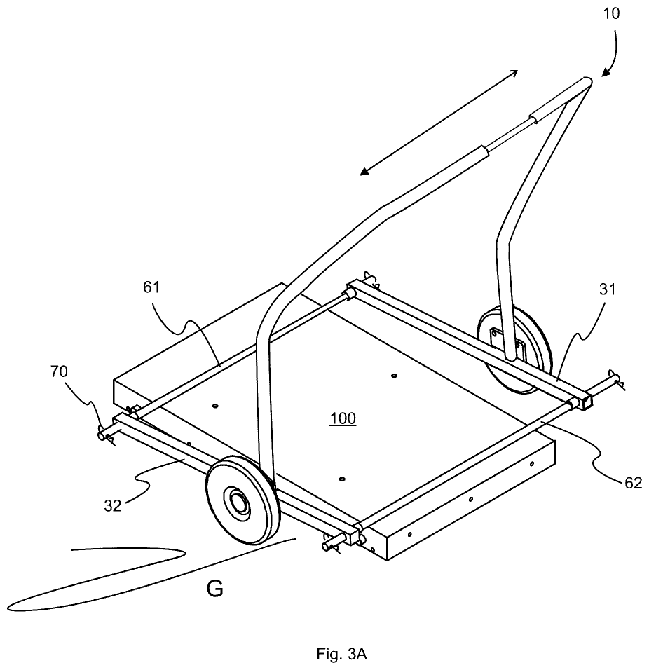

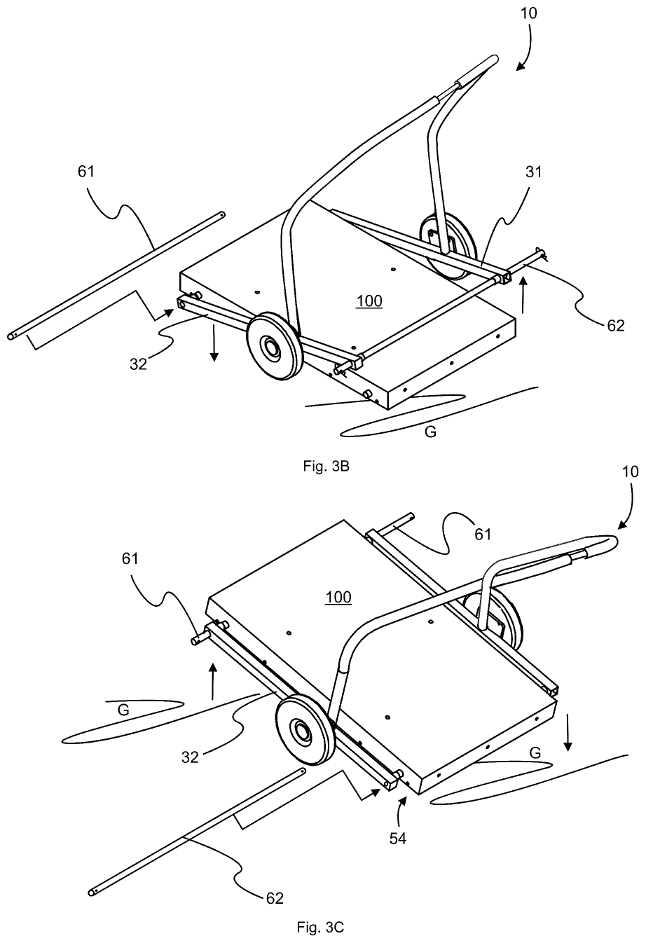

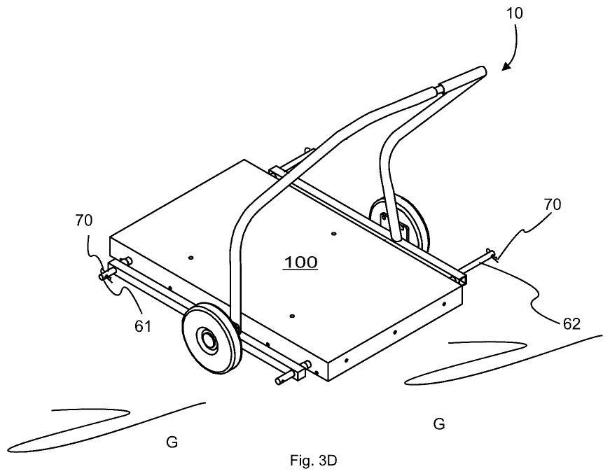

Referring now to FIGS. 3A, 3B, 3C, and 3D, by way of example, and not limitation, there is illustrated an example embodiment of transport cart 10 engaging slab 100. In use, transport cart 10 is preferably positioned above, over, and alongside slab 100. Transport cart 10 is widened width-wise to accommodate the width of slab 100.

Disassembly may include removing latch(s) 70 from pins 60, including first or front pin 61 and second or back pin 62, and removing pins 60, including first or front pin 61 and second or back pin 62 from collar(s) 50 of lifting arms 30 preferably first or left lifting arm 31 and second or right lifting arm 32. Aligning collar(s) 50 of lifting arms 30, preferably first or left lifting arm 31 and second or right lifting arm 32 with first conduit 201 and second conduit 202 of slab 200, respectively.

Assembly may include inserting first or front pin 61 through first collar 51 of first or left lifting arm 31, through first conduit 201, and through third collar 53 of second or right lifting arm 32. Next, insert second or back pin 62 through second collar 52 of first or left lifting arm 31, through second conduit 202, and through fourth collar 54 of second or right lifting arm 32. Next, attaching latch(s) 70 to ends of first conduit 201 and second conduit 202 extending past first or left lifting arm 31 and second or right lifting arm 32 to removably secure first or front pin 61 and second or back pin 62 and slab 100 to transport cart 10 with slab 100 therein.

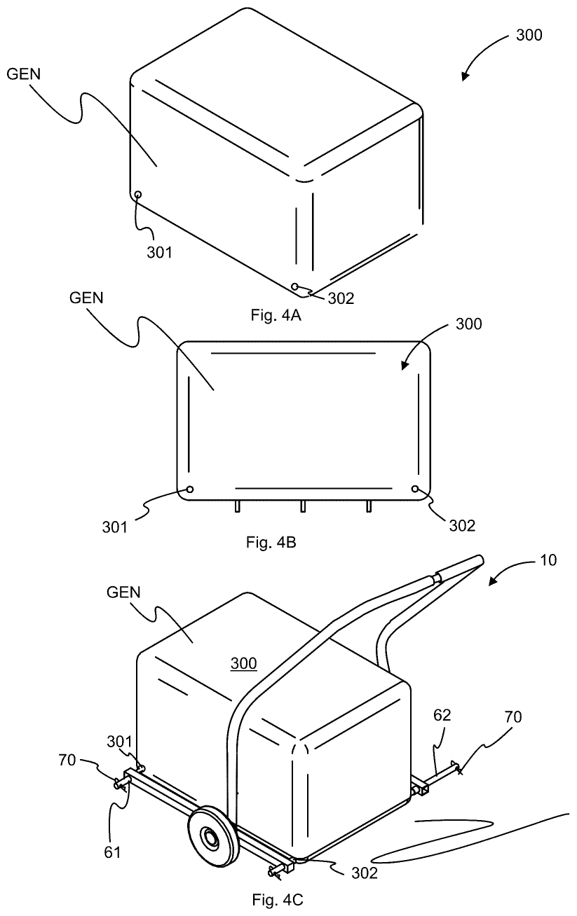

Referring now to FIGS. 4A, 4B, and 4C, by way of example, and not limitation, there is illustrated an example embodiment of transport cart 10 engaging generator 300. In use, transport cart 10 is preferably positioned above, over, and alongside generator 300. Transport cart 10 is widened width-wise to accommodate the width of generator 300. Generator 300 is preferably a box structure having sides. Generator 300 preferably includes two or more spaced apart conduits running therethrough generator 300, such as first conduit 301 and second conduit 302. Conduits, such as first conduit 301 and second conduit 302 are preferably configured to receive one of pins 60, including first or front pin 61 and second or back pin 62 therethrough to generator 300, conduits, pins 60 thereto pair of lifting arms 30 preferably first or left lifting arm 31 and second or right lifting arm 32 of transport cart 10.

Disassembly may include removing latch(s) 70 from pins 60, including first or front pin 61 and second or back pin 62, and removing pins 60, including first or front pin 61 and second or back pin 62 from collar(s) 50 of lifting arms 30 preferably first or left lifting arm 31 and second or right lifting arm 32. Aligning collar(s) 50 of lifting arms 30, preferably first or left lifting arm 31 and second or right lifting arm 32 with first conduit 301 and second conduit 302 of generator 300, respectively.

Assembly may include inserting first or front pin 61 through first collar 51 of first or left lifting arm 31, through first conduit 301, and through third collar 53 of second or right lifting arm 32. Next, insert second or back pin 62 through second collar 52 of first or left lifting arm 31, through second conduit 302, and through fourth collar 54 of second or right lifting arm 32. Next, attaching latch(s) 70 to ends of first conduit 301 and second conduit 302 extending past first or left lifting arm 31 and second or right lifting arm 32 to removably secure first or front pin 61 and second or back pin 62 and slab 100 to transport cart 10 with generator 300 thereon.

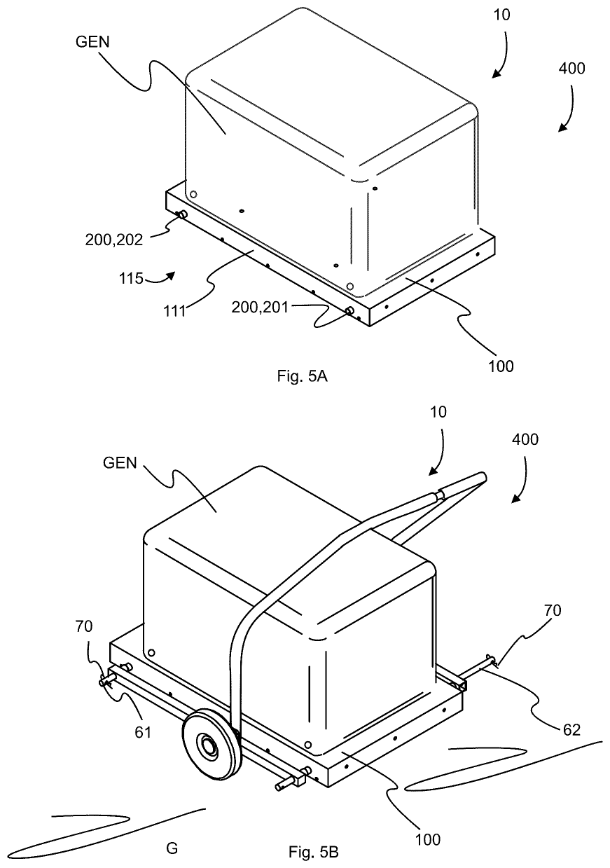

Referring now to FIGS. 5A and 5B, by way of example, and not limitation, there is illustrated an example embodiment of transport cart 10 engaging generator and slab combination 400. In use, transport cart 10 is preferably positioned above, over, and alongside generator and slab combination 400. Transport cart 10 is widened width-wise to accommodate the width of HVAC compressor and slab combination 400. Generator and slab combination 400 is preferably a box structure having sides and mounted to slab 100. Generator and slab combination 400 preferably includes two or more spaced apart conduits running therethrough slab 100 and supporting generator 400, such as first conduit 201 and second conduit 202. Conduits, such as first conduit 201 and second conduit 202 are preferably configured to receive one of pins 60, including first or front pin 61 and second or back pin 62 therethrough slab 100 conduits, pins 60 thereto pair of lifting arms 30 preferably first or left lifting arm 31 and second or right lifting arm 32 of transport cart 10.

Disassembly may include removing latch(s) 70 from pins 60, including first or front pin 61 and second or back pin 62, and removing pins 60, including first or front pin 61 and second or back pin 62 from collar(s) 50 of lifting arms 30 preferably first or left lifting arm 31 and second or right lifting arm 32. Aligning collar(s) 50 of lifting arms 30, preferably first or left lifting arm 31 and second or right lifting arm 32 with first conduit 201 and second conduit 202 of slab 100 of slab 100 of generator and slab combination 400, respectively.

Assembly may include inserting first or front pin 61 through first collar 51 of first or left lifting arm 31, through first conduit 201, and through third collar 53 of second or right lifting arm 32. Next, insert second or back pin 62 through second collar 52 of first or left lifting arm 31, through second conduit 202, and through fourth collar 54 of second or right lifting arm 32. Next, attaching latch(s) 70 to ends of first conduit 201 and second conduit 202 extending past first or left lifting arm 31 and second or right lifting arm 32 to removably secure first or front pin 61 and second or back pin 62 and slab 100 to transport cart 10 with generator and slab combination 400 thereon.

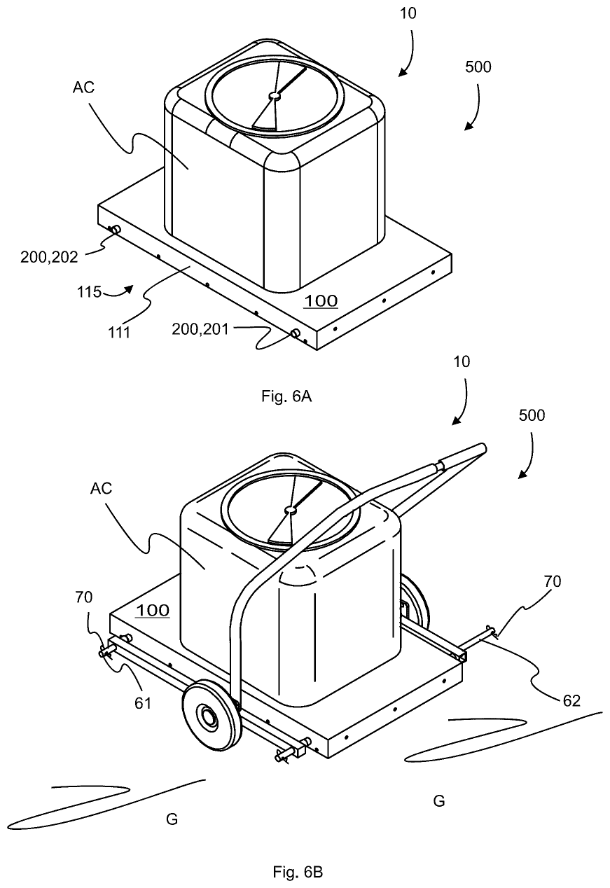

Referring now to FIGS. 6A and 6B, by way of example, and not limitation, there is illustrated an example embodiment of transport cart 10 engaging AC compressor and slab combination 400. In use, transport cart 10 is preferably positioned above, over, and alongside HVAC compressor and slab combination 400. Transport cart 10 is widened width-wise to accommodate the width of HVAC compressor and slab combination 400. AC compressor and slab combination 400 is preferably a box structure having sides and mounted to slab 100. AC compressor and slab combination 400 preferably includes two or more spaced apart conduits running therethrough slab 100 and supporting AC compressor 400, such as first conduit 201 and second conduit 202. Conduits, such as first conduit 201 and second conduit 202 are preferably configured to receive one of pins 60, including first or front pin 61 and second or back pin 62 therethrough slab 100, conduits, pins 60 thereto pair of lifting arms 30 preferably first or left lifting arm 31 and second or right lifting arm 32 of transport cart 10.

Disassembly may include removing latch(s) 70 from pins 60, including first or front pin 61 and second or back pin 62, and removing pins 60, including first or front pin 61 and second or back pin 62 from collar(s) 50 of lifting arms 30 preferably first or left lifting arm 31 and second or right lifting arm 32. Aligning collar(s) 50 of lifting arms 30 preferably first or left lifting arm 31 and second or right lifting arm 32 with first conduit 201 and second conduit 202 of slab 100 of AC compressor and slab combination 400, respectively.

Assembly may include inserting first or front pin 61 through first collar 51 of first or left lifting arm 31, through first conduit 201, and through third collar 53 of second or right lifting arm 32. Next, insert second or back pin 62 through second collar 52 of first or left lifting arm 31, through second conduit 202, and through fourth collar 54 of second or right lifting arm 32. Next, attaching latch(s) 70 to ends of first conduit 201 and second conduit 202 extending past first or left lifting arm 31 and second or right lifting arm 32 to removably secure first or front pin 61 and second or back pin 62 and slab 100 to transport cart 10 with AC compressor and slab combination 400 thereon.

It is contemplated herein that other devices and or slab combinations may be transported via engaging first or front pin 61 and second or back pin 62.

It is contemplated herein that conduits 200, 301, and 302 may be substituted for pins 60 (now marked as 200, 301, and 302) and integrated into portable equipment PE and be utilized directly to removably attach a variety of portable equipment PE for direct transport of portable equipment by transport cart 10.

Concerning the description herein, it is to be realized that the optimum dimensional relationships, including variations in size, materials, shape, form, configuration, position, connection, function and manner of operation, assembly, and use, are intended to be encompassed by the present disclosure.

It is further understood herein that the parts and elements of this disclosure may be located or positioned elsewhere based on one of ordinary skill in the art without deviating from the present disclosure.

With respect to the above description, it is to be realized that the optimum dimensional relationships, including variations in size, materials, shape, form, position, movement mechanisms, function and manner of operation, assembly and use, are intended to be encompassed by the present disclosure.

The foregoing description and drawings comprise illustrative embodiments. Regarding the described exemplary embodiments, it should be noted by those skilled in the art that the disclosures within are exemplary only and that various other alternatives, adaptations, and modifications may be made within the scope of the present disclosure. Merely listing or numbering the steps of a method in a particular order does not constitute any limitation on the order of the steps of that method. Many modifications and other embodiments will come to mind for one skilled in the art to which this disclosure pertains, having the benefit of the teachings presented in the foregoing descriptions and the associated drawings. Although specific terms may be employed herein, they are used in a generic and descriptive sense only and not for purposes of limitation. Moreover, the present disclosure has been described in detail; it should be understood that various changes, substitutions, and alterations can be made thereto without departing from the spirit and scope of the disclosure as defined by the appended claims. Accordingly, the present disclosure is not limited to the specific embodiments illustrated herein but is limited only by the following claims.

1. A transport apparatus for carrying a portable device, comprising:
at least two wheels;
a pair of lifting arms having a first lifting arm and a second lifting arm, each said pair of lifting arms being rotationally connected to one of said at least two wheels, wherein each of said pair of lifting arms includes a spaced apart pair of apertures configured to receive a set of carrying pins slidable therein; and
a pair of lever arms having a first lever arm and a second lever arm, wherein said first lever arm is pivotably affixed to said first lifting arm and said second lever arm is pivotably affixed to said second lifting arm.

2. The transport apparatus of claim 1, further comprising a portable device having at least two conduits formed therein, said portable device being removably affixed to said pair of lifting arms by said set of carrying pins positioned through said at least two conduits and said spaced apart pair of apertures of each of said pair of lifting arms.

3. The transport apparatus of claim 2, wherein said portable device is a portable slab.

4. The transport apparatus of claim 2, wherein said portable device is an AC compressor.

5. The transport apparatus of claim 2, wherein said portable device is a generator.

6. The transport apparatus of claim 2, wherein said portable device having a combination of an AC compressor and a portable slab.

7. The transport apparatus of claim 2, wherein said portable device having a combination of a generator and a portable slab.

8. The transport apparatus of claim 1, wherein said pair of lifting arms are width-adjustable relative to each other.

9. The transport apparatus of claim 1, further comprising a crossbar positioned between said first lever arm and said second lever arm.

10. The transport apparatus of claim 9, wherein said crossbar enables said pair of lever arms are width adjustable relative to each other.

11. The transport apparatus of claim 1, wherein said spaced apart pair of apertures on each of said pair of lifting arms having slotted collars.

12. The transport apparatus of claim 1, wherein said set of carrying pins varies in at least one of size, material, shape, or form.

13. The transport apparatus of claim 1, wherein said at least two wheels each having an axle and a mounting plate rotationally affixed to one of said first lifting arm and said second lifting arm.

14. The transport apparatus of claim 1, wherein said first lever arm is affixed to said first lifting arm and said second lever arm is affixed to said second lifting arm proximate a position between one of said at least two wheels and an end of said first lever arm and said second lever arm, respectively.

15. The transport apparatus of claim 1, wherein said transport apparatus is configured for deployment in uneven terrain.

16. The transport apparatus of claim 14, wherein a set of carrying rods is integrated into said portable device for direct transport of said portable device.

17. The transport apparatus of claim 1, further comprising a first cable removably affixed between said first lifting arm and said first lever arm and a second cable removably affixed between said second lifting arm and said second lever arm to assist with lifting an object affixed to said first lifting arm and said second lifting arm.

18. The transport apparatus of claim 13, further comprising a pair of lifting cams integrated with said mounting plate, said pair of lifting cams configured to raise said first lifting arm and said second lifting arm when said first lever arm and said second lever arm are raised, and said pair of lifting cams configured to lower said first lifting arm and said second lifting arm when said first lever arm and said second lever arm are lowered.

19. The transport apparatus of claim 1, further comprising a planar dimensioned solidifying material with one or more elongated reinforcement devices imbedded therein, at least two spaced apart conduits positioned therethrough said material, each said at least two spaced apart conduits to receive one of said set of carrying pins.

20. A transport apparatus for carrying a portable device, said apparatus comprising:
at least two wheels;
a first lifting arm and a second lifting arm, each rotationally connected to at least one of said at least two wheels, wherein each of said first lifting arm and said second lifting arm includes a pair of slotted collars configured to receive a set of carrying rods slidable therein;
a first lever arm affixed to said first lifting arm and a second lever arm affixed to said second lifting arm; and
a portable device selected from a group consisting of a portable slab, an AC compressor, a generator, and a combination thereof, said portable device having at least two conduit sections formed therein, wherein said portable device is removably affixed to said first lifting arm and said second lifting arm by said set of carrying rods positioned through said at least two conduit sections and said pair of slotted collars of each of said first lifting arm and said second lifting arm.

21. The transport apparatus of claim 20, wherein said first lifting arm and said second lifting arm are adjustable in width relative to each other to accommodate portable devices of varying sizes.

22. The transport apparatus of claim 20, further comprising a width-adjustable crossbar connecting said first lever arm and said second lever arm to make them adjustable in width relative to each other to accommodate portable devices of varying sizes.

23. The transport apparatus of claim 20, wherein said transport apparatus is configured for deployment in uneven terrain.

24. The transport apparatus of claim 20, wherein said set of carrying rods is integrated into said portable device.

25. A mounting pad, said mounting pad comprising:
a planar dimensioned solidifying material;
one or more elongated reinforcement devices imbedded therein said material to strengthen said material; and
at least two spaced apart conduits positioned therethrough said material.
